(19) United States
(12) Patent Application Publication
(10) Pub. No.: US 2022/0335180 A1
(43) Pub. Date: Oct. 20, 2022

(54) PROPERLY FUNCTIONING 3D PART ASSEMBLY DETERMINATIONS

(71) Applicant: Hewlett-Packard Development Company, L.P., Spring, TX (US)

(72) Inventors: Jordi ROCA VILA, Sant Cugat del Valles (ES); Guiu TIO MEDINA, Sant Cugat del Valles (ES); Sergio GONZALEZ MARTIN, Sant Cugat del Valles (ES)

(73) Assignee: Hewlett-Packard Development Company, L.P., Spring, TX (US)

(21) Appl. No.: 17/235,494

(22) Filed: Apr. 20, 2021

(51) Int. Cl. G06F 30/23; B29C 64/393

(52) U.S. Cl. CPC G06F 30/23; B29C 64/393; B33Y 80/00

(57) ABSTRACT

According to examples, a processor may dilate a first digital model of a first 3D part a predefined amount and a second digital model of a second 3D part the predefined amount, in which the first 3D part and the second 3D part are to be fabricated together in an assembly to have a functional relationship with respect to each other, and in which the first digital model and the second digital model are spaced from each other in a manner that corresponds to a spacing of the first 3D part and the second 3D part in the assembly. The processor may determine a spatial relationship between the dilated first digital model and the dilated second digital model and may determine, based on the determined spatial relationship, whether the assembly of the first 3D part and the second 3D part is predicted to function properly when the assembly is fabricated.

### BACKGROUND

In three-dimensional (3D) printing, an additive printing process may be used to make 3D parts from a digital model. 3D printing techniques are considered additive processes because they involve the application of successive layers or volumes of a build material, such as a powder or powder-like build material, to an existing surface (or previous layer). 3D printing often includes solidification of the build material, which for some materials may be accomplished through use of heat, a chemical binder, and/or an ultra-violet or a heat curable binder.

### BRIEF DESCRIPTION OF DRAWINGS

Features of the present disclosure are illustrated by way of example and not limited in the following figure(s), in which like numerals indicate like elements, in which:

FIG. 1 shows a block diagram of an example computer-readable medium that may have stored thereon computer-readable instructions for determining whether an assembly of a first 3D part and a second 3D part is predicted to function properly when the assembly is fabricated;

FIG. 2 shows a diagram of an apparatus, which includes an example processor that may execute the computer-readable instructions stored on the example computer-readable medium depicted in FIG. 1;

FIGS. 3A-3C, respectively, depict diagrams of example spatial relationships between a dilated first digital model and a dilated second digital model; and

FIG. 4 depicts a flow diagram of an example method for determining whether an assembly of a first 3D part and a second 3D part is predicted to function properly when the assembly is fabricated.

### DETAILED DESCRIPTION

For simplicity and illustrative purposes, the principles of the present disclosure are described by referring mainly to examples thereof. In the following description, numerous specific details are set forth in order to provide an understanding of the examples. It will be apparent, however, to one of ordinary skill in the art, that the examples may be practiced without limitation to these specific details. In some instances, well known methods and/or structures have not been described in detail so as not to unnecessarily obscure the description of the examples. Furthermore, the examples may be used together in various combinations.

Throughout the present disclosure, the terms “a” and “an” are intended to denote at least one of a particular element. As used herein, the term “includes” means includes but not limited to, the term “including” means including but not limited to. The term “based on” means based at least in part on.

Disclosed herein are computer-readable media, methods, and apparatuses, in which a processor may determine a spatial relationship between dilated versions of digital models of parts that are to have a functional relationship within an assembly. The parts may be fabricated together in the assembly to have the functional relationship. Based on the determined spatial relationship, the processor may determine whether the assembly of the parts is predicted to function properly when the assembly is fabricated. The dilated versions of the digital models may correspond to, for instance, deviations in the fabricated parts from their respective digital models. The deviations may occur due to variances in types of materials used to fabricate the parts, variances in the types of processes used to fabricate the parts, and/or the like.

Through implementation of the features of the present disclosure, the processor may determine whether the assembly is predicted to function properly prior to the assembly being fabricated. As a result, when an assembly is predicted to function properly, the assembly may be fabricated. However, when an assembly is predicted to function improperly, a notification may be issued to alert a user or designer of the possible defect in the assembly and the user or designer may modify some or all of the digital models. The modified digital model(s) may be used to fabricate the assembly to better ensure that a properly functioning assembly is fabricated.

A technical improvement afforded by the present disclosure may be that the fabrication of improperly functioning assemblies may be detected prior to 3D printing of the assemblies, and thereby avoiding the printing of non-functioning assemblies.

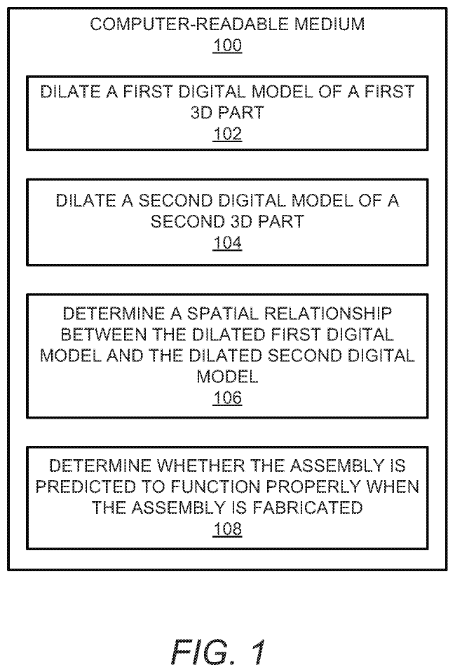

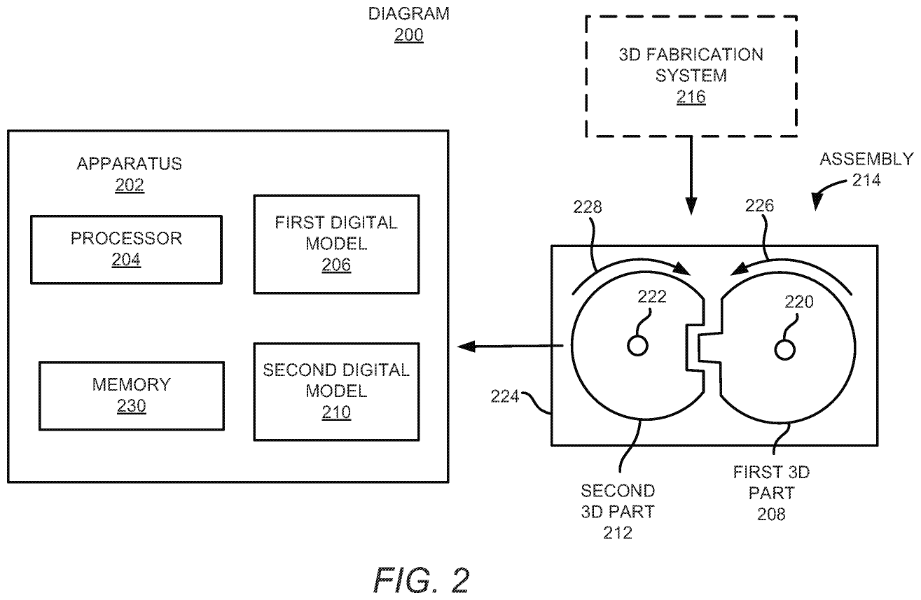

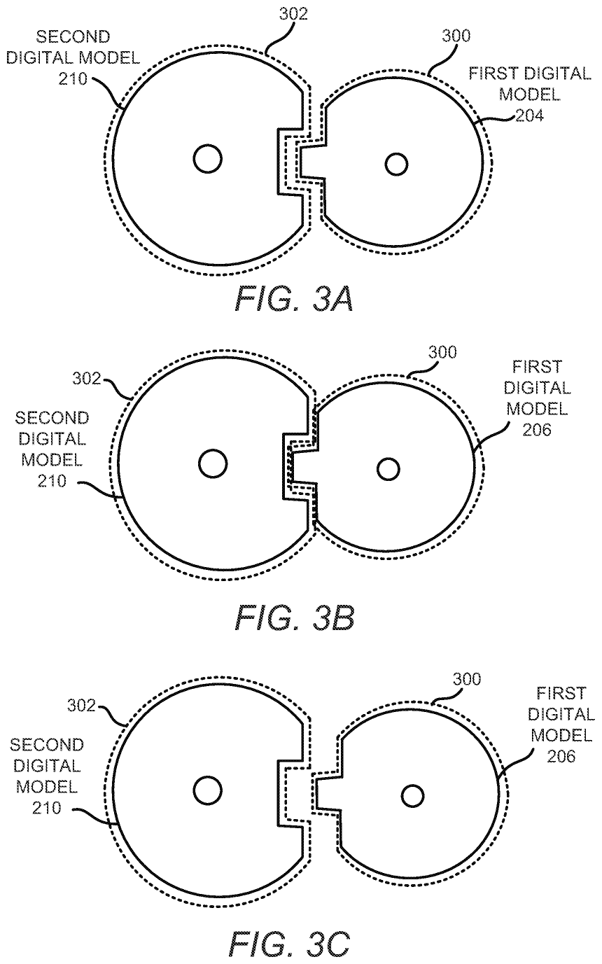

Reference is first made to FIGS. 1-3C. FIG. 1 shows a block diagram of an example computer-readable medium 100 that may have stored thereon computer-readable instructions for determining whether an assembly 214 of a first 3D part 208 and a second 3D part 212 is predicted to function properly when the assembly 214 is fabricated. FIG. 2 shows a diagram 200 of an apparatus 202, which includes an example processor 204 that may execute the computer-readable instructions stored on the example computer-readable medium 100 depicted in FIG. 1. FIGS. 3A-3C, respectively, depict diagrams of example spatial relationships between a dilated first digital model 300 and a dilated second digital model 302. It should be understood that the computer-readable medium 100, the apparatus 202, and/or the elements shown in FIGS. 3A-3C may include additional features and that some of the features described herein may be removed and/or modified without departing from the scopes of the computer-readable medium 100, the apparatus 202, and/or the features depicted in FIGS. 3A-3C discussed herein.

The computer-readable medium 100 may have stored thereon computer-readable instructions 102-108 that a processor, such as the processor 204 depicted in FIG. 2, may execute. The computer-readable medium 100 may be an electronic, magnetic, optical, or other physical storage device that contains or stores executable instructions. The computer-readable medium 100 may be, for example, Random Access memory (RAM), an Electrically Erasable Programmable Read-Only Memory (EEPROM), a storage device, an optical disc, and the like. Generally speaking, the computer-readable medium 100 may be a non-transitory computer-readable medium, in which the term “non-transitory” does not encompass transitory propagating signals.

The processor 204 may fetch, decode, and execute the instructions 102 to dilate a first digital model 206 of a first three-dimensional (3D) part 208 a predefined amount. In addition, the processor 204 may fetch, decode, and execute the instructions 104 to dilate a second digital model 210 of a second 3D part 212 the predefined amount. The first 3D part 208 and the second 3D part 212 may be fabricated together in an assembly 214 to have a functional relationship with respect to each other. As shown in the example depicted in FIG. 2, a 3D fabrication system 216 may fabricate the first 3D part 208 and the second 3D part 212 as part of a functional assembly 214. In other words, the first 3D part 208 and the second 3D part 212 may be fabricated concurrently, e.g., together in a common build volume of the 3D fabrication system 216, to be in a functional, e.g., working, relationship with respect to each other.

By way of example, and as shown in FIG. 2, the first 3D part 208 and the second 3D part 212 may be fabricated to rotate about respective axles 220, 222 as denoted by the arrows 226, 228. The 3D fabrication system 216 may fabricate each of the components of the assembly 214 together such that, for instance, the axles 220, 222 are formed to be fixedly attached to a base 224 and the first and second 3D parts 208, 212 are formed to be rotatably connected to the axles 220, 222. In addition, each of the first 3D part 208 and the second 3D part 212 may include features that enable a functional relationship with respect to each other. That is, in the example shown in FIG. 2, rotation of the first 3D part 208 may cause the second 3D part 212 to rotate and vice versa. Although the first and second 3D parts 208, 212 have been depicted with a single engagement arrangement, it should be understood that the first and second 3D parts 208, 212 may include a number of engagement arrangements, e.g., teeth in gears. In other examples, the first 3D part 208 and the second 3D part 212 may have other types of functional relationships with respect to each other and/or to other parts. For instance, the first 3D part 208 and the second 3D part 212 may have a linearly movable functional relationship with respect to each other.

As other examples, the base 224 may be an enclosure within which the first 3D part 208 and the second 3D part 212 may be housed. In these examples, the first 3D part 208 and the second 3D part 212 may be fabricated within the enclosure formed by the base 224 as the first 3D part 208 and the second 3D part 212 may not be inserted into the interior of the enclosure formed by the base 224 following fabrication of the base 224.

The first 3D part 208 may be positioned within a certain distance from the second 3D part 212 in order for the first 3D part 208 and the second 3D part 212 to function properly. In instances in which the first 3D part 208 is fabricated to be a sufficient distance to the second 3D part 212 to cause greater than intended contact, the functional movements of the first 3D part 208 and the second 3D part 212 may be hindered and thus, the assembly 214 may function improperly. This may occur when the first 3D part 208 and/or the second 3D part 212 have grown to have sizes that are greater than were predicted in the first and/or second digital models 206, 210 due to the printing processed used. The assembly 214 may be construed as functioning improperly when the assembly 214 does not function as intended or is not within a predefined tolerance from the intended function. For instance, a portion of the first 3D part 208 may become unintentionally fused with a portion of the second 3D part 212 during fabrication of the assembly 214. Likewise, in instances in which the first 3D part 208 is fabricated to be a sufficient distance from the second 3D part 212 to prevent proper contact between the parts 208, 212, for instance, due to the first 3D part 208 and/or the second 3D part 212 having grown to sizes that are smaller than were predicted due to the printing processed used, the assembly 214 may also function improperly. For instance, the first 3D part 208 may be fabricated too far away from the second 3D part 212 to enable sufficient contact between the parts 208, 212.

In many instances, the 3D fabrication system 216 may use any of a number of different types of materials and/or processes to fabricate the assembly 214 based on the same 3D models 206, 210. The different types of materials, which may be different types of build materials, binding agents, fusing agents, and/or the like, and/or processes may result in the first and/or second 3D parts 208, 212 being formed to have dimensions that may vary from the dimensions included in the 3D models 206, 210. The different types of materials and/or processes may also or alternatively result in the first and second 3D parts 208 being formed at positions that may differ from those identified in the first and second digital models 206, 210.

The amounts of deviation may differ for different types of materials and/or processes. As a result, use of the same models 206, 210 may result in the assembly 214 functioning properly when the assembly 214 is fabricated using a first type of material and/or process but may result in the assembly 214 functioning improperly when the assembly 214 is fabricated using a second type of material and/or process. The determination as to whether the assembly 214 functions properly may not be made until the assembly 214 is fabricated, which may result in wasted materials, wasted resource usage, additional costs, and/or the like.

As discussed herein, a prediction as to whether the components of an assembly 214 that may be fabricated together may function properly may be made prior to the assembly 214 being fabricated. As a result, changes may be made prior to the assembly 214 being fabricated such that there is a greater likelihood that the assembly 214 will function properly when fabricated. This may also result in reductions in wasted material, resource usage, costs, and/or the like.

The processor 204 may obtain, e.g., access, download, retrieve, or the like, the first digital model 206 and the second digital model 210 from a data source (not shown) as a single data file or as multiple data files. The data source may be local to the apparatus 202 or may be remote from the apparatus 202 and thus, for instance, the processor 204 may obtain the digital models 206, 210 from a local data storage via a local connection or from a remote data storage via a network connection, e.g., the Internet. The processor 204 may also obtain digital models of the other components of the assembly 214, such as the base 224 and the axles 220, 222.

The first digital model 206 and the second digital model 210 may be respective 3D computer models of the first 3D part 208 and the second 3D part 212, such as computer aided design (CAD) files, print-ready files (such as a 3D manufacturing format (3MF) files), and/or the like, or other digital representations of these components. By way of example, the first digital model 206 and the second digital model 210 may be mesh models and particularly, digital 3D triangle mesh models. In other words, the first digital model 206 and the second digital model 210 may each include a set of triangles that may be connected to other triangles by their common edges and/or corners, in which the set of triangles may represent surfaces of the first digital model 206 and the second digital model 210. Generally speaking, the resolutions of the first digital model 206 and the second digital model 210 may be increased through use of smaller triangles, but the amount of space in a file used to store the digital models 206, 210 may also be increased to represent the increased number of triangles. Additionally, a greater number of triangles may be used to represent smoother curvatures in the surfaces of the digital models 206, 210.

As discussed herein, the processor 204 may fetch, decode, and execute the instructions 102 and 104 to dilate, or equivalently, enlarge, the first digital model 206 and the second digital model 210 a predefined amount. According to examples, the processor 204 may dilate the first digital model 206 and the second digital model 210 in a mesh space, e.g., while the first and second digital models 206 and 210 are mesh, e.g., triangle mesh, versions. In other examples, the processor 204 may transform the first digital model 206 into a voxel space and may transform the second digital model 210 into the voxel space. In some examples, the 3D fabrication system 216 may use the first and second digital models 206 and 210 in the voxel space to fabricate the assembly 214. The processor 204 may also dilate the first digital model 206 in the voxel space and may dilate the second digital model 210 in the voxel space. In these examples, the predefined amount of dilation may be a predefined number of voxels. In any of these examples, the processor 204 may dilate the first digital model 206 and the second digital model 210 while the first digital model 206 and the second digital model 210 are arranged to be in a functional relationship with each other, for instance, as shown in FIG. 2

Examples in which the processor 204 may dilate the first digital model 206 and the second digital model 210 are shown in FIGS. 3A-3C. Particularly, as shown in those figures, the processor 204 may dilate the first digital model 206 to have a size as shown as the dilated first digital model 300. The processor 204 may also dilate the second digital model 210 to have a size as shown as the dilated second digital model 302. The processor 204 may dilate the first digital model 206 and the second digital model 210 by the same amounts with respect to each other and may dilate the models 206, 210 equally around the peripheries of the models 206, 210. In some examples, the processor 204 may dilate the models 206, 210 around the periphery of the models 206, 210 in their entireties. In other examples, the processor 204 may dilate functional portions of the models 206, 210, in which the functional portions may be the portions of the models 206, 210 that are to engage each other.

In some examples, the processor 204 may determine the predefined amount at which the first and second digital models 206, 210 are to be dilated prior to dilating the first and second digital models 206, 210. The processor 204 may determine the predefined amount based on various factors pertaining to, for instance, the type of 3D fabrication system that is to fabricate the first and second 3D parts 208, 212. The predefined amount, e.g., the predefined number of units, to which the first digital model 206 and the second digital model 210 may be dilated may be based on any of a number of factors. For instance, the predefined amount may be related to a type of material to be used to fabricate the assembly 214, a fabrication profile of a 3D fabrication system 216 that is to fabricate the assembly 214, and/or the like. The fabrication profile may include, for instance, the type of fabrication processes to be applied to the material during fabrication of the assembly 214. The fabrication processes may include a fusion of material particles using binding agents, application of heat to the material particles and agents, a laser sintering process, and/or the like. In any of these examples, the spatial relationship between the first 3D part 208 and the second 3D part 212 may vary depending on the type of material used and/or the fabrication profile of the 3D fabrication system 216 used due to, for instance, different levels of thermal bleed and other variables that may arise during fabrication of the assembly 214.

In some examples, the predefined amount, e.g., predefined number of voxels, or other distance parameters, for various types of build materials and/or 3D fabrication systems that may be used to fabricate the assembly 214 may have been determined through testing, modeling, simulation, and/or the like. This information may be stored, for instance, in a lookup table and the processor 204 may access this information to determine the distances, e.g., the predefined amounts, at which the first and second digital models 206, 210 are to be dilated. In some examples, the first 3D part 208 may be fabricated using a different material and/or fabrication process as compared with the second 3D part 212. In these examples, the processor 204 may determine different levels of dilation for each of the digital models 206, 210, in which the different levels may correspond to the differences in the fabrication of the first 3D part 208 and the second 3D part 212.

The processor 204 may fetch, decode, and execute the instructions 106 to determine a spatial relationship between the dilated first digital model 300 and the dilated second digital model 302. In some examples, the processor 204 may determine the spatial relationship, e.g., the distances between sections of the dilated models 300, 302, while positions of the dilated models 300, 302 correspond to respective positions of the first 3D part 208 and the second 3D part 212 in the fabricated assembly 214 to have an intended functional relationship with each other.

The processor 204 may fetch, decode, and execute the instructions 108 to determine, based on the determined spatial relationship, whether the assembly 214 of the first 3D part 208 and the second 3D part 212 is predicted to function properly when the assembly 214 is fabricated. Equivalently, the processor 204 may determine whether the assembly 214 is predicted to function improperly when the assembly 214 is fabricated based on the first digital model 206 and the second digital model 210.

In some examples, the processor 204 may determine that the assembly 214 is predicted to function properly in instances in which the spatial distance between the dilated models 300, 302 is beyond a predefined distance. This example is shown in FIG. 3A. However, the processor 204 may determine that the assembly 214 is predicted to function improperly in instances in which the spatial distance between the dilated models 300, 302 is within the predefined distance. The predefined distance may be user-defined, determined through testing, modeling, simulation, and/or the like. By way of example, the predefined distance may be sufficiently small distance, e.g., a distance at which a portion of the dilated first model 300 overlaps with a portion of the second dilated model 302. An example of a portion of the dilated first model 300 overlapping with a portion of the second dilated model 302 is shown in FIG. 3B.

In addition, or in other examples, the processor 204 may determine that a distance between a portion of the dilated first digital model 300 and a portion of the dilated second digital model 302 exceeds a predefined distance. The predefined distance may be a distance at which there may be a likelihood that rotation or other movement of the first 3D part 208 may not result in an intended movement of the second 3D part 212. The predefined distance may be determined through testing, modeling, simulation, and/or the like. In addition, the processor 204 may determine the predefined distance from additional information regarding the digital models 206, 210, e.g., metadata associated with the digital models 206, 210 that may include the additional information. The processor 204 may, based on a determination that the portion of the dilated first digital model 300 and the portion of the dilated second digital model 302 exceeds the predefined distance, determine that the assembly 214 of the first 3D part 208 and the second 3D part 212 is predicted to function improperly when the assembly 214 is fabricated.

The processor 204 may proceed with the fabrication process of the assembly 214 based on a determination that an assembly 214 that is fabricated based on the first digital model 206 and the second digital model 210 is predicted to function properly. However, based on a determination that the assembly 214 is predicted to function improperly, the processor 204 may output a notification that indicates that the assembly 214 of the first 3D part 208 and the second 3D part 212 is predicted to function improperly when fabricated. A user or designer may thus be informed to modify the first digital model 206 and/or the second digital model 210 such that the assembly 214 may be fabricated to function properly.

In any of the examples discussed herein, the processor 204 may control fabrication components (not shown) of the 3D fabrication system 216 to fabricate the assembly 214 using the digital models 206, 210. The processor 204 may, in some examples, be a processor 204 of an apparatus 202 that is external to the 3D fabrication system 216, while in other examples, the processor 204 may be part of the 3D fabrication system 216. Thus, for instance, the processor 204 may determine whether the assembly 214 is predicted to function improperly prior to the models 206, 210 being communicated to the 3D fabrication system 216. In addition, or alternatively, the processor 204 may make this determination after receiving the models 206, 210 in the 3D fabrication system 216. In these examples, a processor or controller of the 3D fabrication system 216 may determine whether the assembly 214 is predicted to function improperly or properly.

The 3D fabrication system 216 may be any suitable type of additive manufacturing system. Examples of suitable additive manufacturing systems may include systems that may employ curable binder jetting onto build materials (e.g., thermally or UV curable binders), liquid print agent jetting onto build materials, selective laser sintering, stereolithography, fused deposition modeling, etc. In a particular example, the 3D fabrication system 216 may form the assembly 214 by binding and/or fusing build material particles together. In any of these examples, the build material particles may be any suitable type of material that may be employed in 3D fabrication processes, such as, a metal, a plastic, a nylon, a ceramic, an alloy, and/or the like.

In some examples, the processor 204 may be part of an apparatus 202, which may be a computing system such as a server, a laptop computer, a tablet computer, a desktop computer, or the like. The processor 204 may be a semiconductor-based microprocessor, a central processing unit (CPU), an application specific integrated circuit (ASIC), a field-programmable gate array (FPGA), and/or other suitable hardware device. The apparatus 202 may also include a memory 230 that may have stored thereon computer-readable instructions (which may also be termed computer-readable instructions) that the processor 204 may execute, such as the computer-readable medium 100 depicted in FIG. 1.

Although the apparatus 202 is depicted as having a single processor 204, it should be understood that the apparatus 202 may include additional processors and/or cores without departing from a scope of the apparatus 202. In this regard, references to a single processor 202 as well as to a single computer-readable medium 100 may be understood to additionally or alternatively pertain to multiple processors 204 and multiple memories 230. In addition, or alternatively, the processor 204 and the memory 230 may be integrated into a single component, e.g., an integrated circuit on which both the processor 204 and the memory 230 may be provided. In addition, or alternatively, the operations described herein as being performed by the processor 204 may be distributed across multiple apparatuses 202 and/or multiple processors 204.

By way of example, the memory 230 may have stored thereon instructions that when executed by the processor 204, may cause the processor 204 to dilate a first digital model 206 of a first 3D part 208 a predefined amount and to dilate a second digital model 210 of a second 3D part 212 the predefined amount, in which positions of the first digital model 206 and the second digital model 210 correspond to positions of the first 3D part 208 and the second 3D part 212 when an assembly 214 of the first 3D part 208 and the second 3D part 212 is fabricated and in which the first 3D part 208 and the second 3D part 212 are to be fabricated together in the assembly 214 to have a functional relationship with respect to each other. As discussed herein, the processor 204 may transform the first digital model 206 into a voxel space and may dilate the first digital model 206 in the voxel space. The processor 204 may also transform the second digital model 210 into the voxel space and may dilate the second digital model 210 in the voxel space.

The instructions may also cause the processor 204 to determine a spatial relationship between the dilated first digital model 300 and the dilated second digital model 302 and to determine whether a portion of the dilated first digital model 300 overlaps with a portion of the dilated second digital model 302. Based on a determination that the portion of the dilated first digital model 300 overlaps with the portion of the dilated second digital model 302, the instructions may further cause the processor 204 to determine that the assembly 214 of the first 3D part 208 and the second 3D part 212 is predicted to function improperly when the assembly 214 is fabricated. The instructions may further cause the processor 204 to output a notification that indicates that the assembly 214 of the first 3D part 208 and the second 3D part 212 is predicted to function improperly when fabricated.

According to examples, in which the first 3D part 208 rotates around the axle 220 and the second 3D part 212 rotates around the axle 222, the processor 204 may determine whether the assembly of these components is predicted to function properly in manners similar to those discussed above with respect to the functional relationship between the first 3D part 208 and the second 3D part 212.

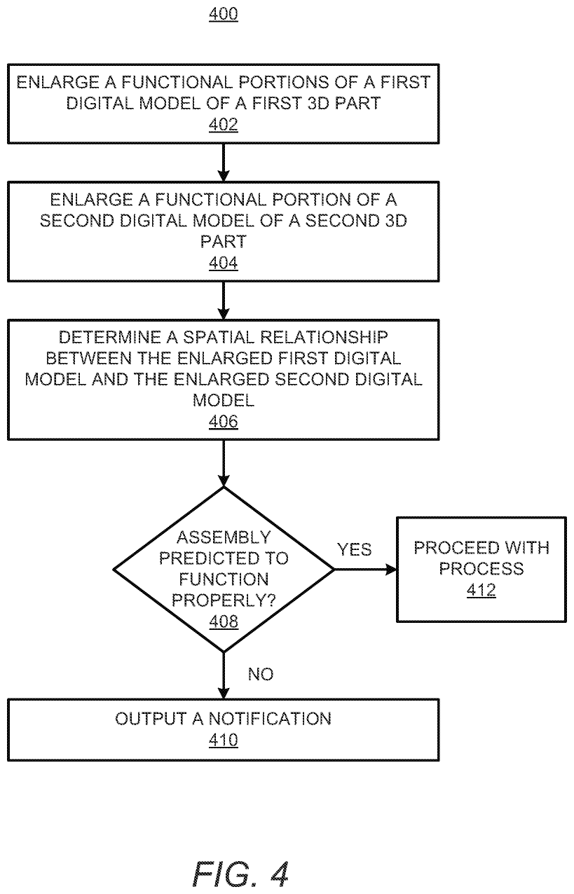

Various manners in which a processor 204 may operate are discussed in greater detail with respect to the method 400 depicted in FIG. 4. Particularly, FIG. 4 depicts a flow diagram of an example method 400 for determining whether an assembly 214 of a first 3D part 208 and a second 3D part 212 is predicted to function properly when the assembly 214 is fabricated. It should be understood that the example method 400 may include additional operations and that some of the operations described herein may be removed and/or modified without departing from the scope of the method 400. The description of the method 400 is made with reference to the features depicted in FIGS. 1-3B for purposes of illustration.

At block 402, the processor 204 may enlarge a functional portion of a first digital model 206 of a first 3D part 208. At block 404, the processor 204 may enlarge a functional portion of a second digital model 210 of a second 3D part 212, in which positions of the first digital model 206 and the second digital model 210 correspond to positions of the first 3D part 208 and the second 3D part 212 when an assembly 214 of the first 3D part 208 and the second 3D part 212 is fabricated. In addition, the positions of the first digital model 206 and the second digital model 210 may correspond to the positions of the first 3D part 208 and the second 3D part 212 while the first 3D part 208 and the second 3D part 212 are in a functional relationship with respect to each other.

As discussed herein, the first 3D part 208 and the second 3D part 212 are to be fabricated together in the assembly 214 to have a functional relationship with respect to each other. As also discussed herein, the processor 204 may enlarge the first digital model 206 and the second digital model 210 by a predefined amount, e.g., a predefined number of units. The predefined amount may be based on properties of the material and/or fabrication processes to be used to fabricate the assembly 214. As further discussed herein, the processor 204 may enlarge mesh versions of the first digital model 206 and the second digital model 210 and/or may enlarge voxelized versions of the models 206, 210.

At block 406, the processor 204 may determine a spatial relationship between the enlarged first digital model 300 and the enlarged second digital model 302. For instance, the processor 204 may determine a distance between the enlarged first digital model 300 and the enlarged second digital model 302.

At block 408, the processor 204 may determine, based on the determined spatial relationship, whether the assembly 214 of the first 3D part 208 and the second 3D part 212 is predicted to function properly when the assembly 214 is fabricated. Based on a determination that the assembly 214 is predicted to function improperly when the assembly 214 is fabricated, at block 410, the processor 204 may output a notification that indicates that the assembly 214 of the first 3D part 208 and the second 3D part 212 is predicted to function improperly when fabricated. However, based on a determination that the assembly 214 is predicted to function properly, the processor 204 may proceed with a fabrication process of the assembly 214. The fabrication process may include, for instance, transforming the first digital model 206 and the second digital model 210 from a mesh space to a voxel space, fabricating the assembly 214, and/or the like.

Some or all of the operations set forth in the method 400 may be included as a utility, program, or subprogram, in any desired computer-accessible medium. In addition, the method 400 may be embodied by a computer program, which may exist in a variety of forms both active and inactive. For example, they may exist as machine-readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A non-transitory computer-readable medium on which is stored machine-readable instructions that when executed by a processor, cause the processor to:
dilate a first digital model of a first three-dimensional (3D) part a predefined amount;
dilate a second digital model of a second 3D part the predefined amount, wherein the first 3D part and the second 3D part are to be fabricated together in an assembly to have a functional relationship with respect to each other, and wherein the first digital model and the second digital model are spaced from each other in a manner that corresponds to a spacing of the first 3D part and the second 3D part in the assembly;
determine a spatial relationship between the dilated first digital model and the dilated second digital model; and
determine, based on the determined spatial relationship, whether the assembly of the first 3D part and the second 3D part is predicted to function properly when the assembly is fabricated.

2. The non-transitory computer-readable medium of claim 1, wherein the instructions cause the processor to:
transform the first digital model into a voxel space;
dilate the first digital model in the voxel space;
transform the second digital model into the voxel space; and
dilate the second digital model in the voxel space.

3. The non-transitory computer-readable medium of claim 1, wherein the first digital model and the second digital model comprise models in a mesh space and wherein the instructions cause the processor to:
dilate the first digital model in the mesh space; and
dilate the second digital model in the mesh space.

4. The non-transitory computer-readable medium of claim 1, wherein the instructions cause the processor to:
determine the spatial relationship while positions of the first digital model and the second digital model correspond to positions of the first 3D part and the second 3D part when the assembly is fabricated and the first 3D part and the second 3D part are in positions to have the functional relationship with respect to each other.

5. The non-transitory computer-readable medium of claim 1, wherein the instructions cause the processor to:
determine whether a portion of the dilated first digital model overlaps with a portion of the dilated second digital model;
based on a determination that the portion of the dilated first digital model overlaps with the portion of the dilated second digital model, determine that the assembly of the first 3D part and the second 3D part is predicted to function improperly when the assembly is fabricated; and
output a notification that indicates that the assembly of the first 3D part and the second 3D part is predicted to function improperly when fabricated.

6. The non-transitory computer-readable medium of claim 1, wherein the instructions cause the processor to:
determine a distance between a portion of the dilated first digital model and a portion of the dilated second digital model exceeds a predefined distance;
based on a determination that the portion of the dilated first digital model and the portion of the dilated second digital model exceeds the predefined distance, determine that the assembly of the first 3D part and the second 3D part is predicted to function improperly when the assembly is fabricated; and
output a notification that indicates that the assembly of the first 3D part and the second 3D part is predicted to function improperly when fabricated.

7. The non-transitory computer-readable medium of claim 1, wherein the instructions cause the processor to:
determine whether the first digital model and/or the second digital model are to be dilated; and
dilate the first digital model and/or the second digital model based on a determination that the first digital model and/or the second digital model are to be dilated.

8. The non-transitory computer-readable medium of claim 1, wherein the predefined amount is related to a type of material to be used to fabricate the assembly and/or a fabrication profile of a 3D fabrication system that is to fabricate the assembly.

9. A method comprising:
enlarging, by a processor, a functional portion of a first digital model of a first three-dimensional (3D) part;
enlarging, by the processor, a functional portion of a second digital model of a second 3D part, wherein spatial positions of the first digital model and the second digital model correspond to positions of the first 3D part and the second 3D part when an assembly of the first 3D part and the second 3D part is fabricated and wherein the first 3D part and the second 3D part are to be fabricated together in the assembly to have a functional relationship with respect to each other;
determining, by the processor, a spatial relationship between the enlarged functional portion of the first digital model and the enlarged functional portion second digital model;
determining, by the processor and based on the determined spatial relationship, whether the assembly of the first 3D part and the second 3D part is predicted to function properly when the assembly is fabricated; and
based on a determination that the assembly is predicted to function improperly when the assembly is fabricated, outputting, by the processor, a notification that indicates that the assembly of the first 3D part and the second 3D part is predicted to function improperly when fabricated.

10. The method of claim 9, further comprising:
transforming the first digital model into a voxel space;
enlarging the first digital model in the voxel space to enlarge the first digital model;
transforming the second digital model into the voxel space; and
enlarging the second digital model in the voxel space to enlarge the second digital model.

11. The method of claim 9, further comprising:
determining whether a portion of the enlarged first digital model overlaps with a portion of the enlarged second digital model; and
based on a determination that the portion of the enlarged first digital model overlaps with the portion of the enlarged second digital model, determining that the assembly of the first 3D part and the second 3D part is predicted to function improperly when the assembly is fabricated.

12. The method of claim 9, further comprising:
determining a distance between a portion of the enlarged first digital model and a portion of the enlarged second digital model exceeds a predefined distance; and
based on a determination that the portion of the enlarged first digital model and the portion of the enlarged second digital model exceeds the predefined distance, determining that the assembly of the first 3D part and the second 3D part is predicted to function improperly when the assembly is fabricated.

13. The method of claim 9, further comprising:
determining a level to which the first digital model and the second digital model are to be increased; and
enlarging the first digital model and the second digital model to the determined level.

14. An apparatus comprising:
a processor: and
a memory on which is stored instructions that when executed by the processor, cause the processor to:
dilate a first digital model of a first three-dimensional (3D) part a predefined amount;
dilate a second digital model of a second 3D part the predefined amount, wherein positions of the first digital model and the second digital model correspond to positions of the first 3D part and the second 3D part when an assembly of the first 3D part and the second 3D part is fabricated and wherein the first 3D part and the second 3D part are to be fabricated together in the assembly to have a functional relationship with respect to each other;
determine a spatial relationship between the dilated first digital model and the dilated second digital model;
determine whether a portion of the dilated first digital model overlaps with a portion of the dilated second digital model; and
based on a determination that the portion of the dilated first digital model overlaps with the portion of the dilated second digital model, determine that the assembly of the first 3D part and the second 3D part is predicted to function improperly when the assembly is fabricated.

15. The apparatus of claim 14, wherein the instructions cause the processor to:
transform the first digital model into a voxel space;
dilate the first digital model in the voxel space;
transform the second digital model into the voxel space; and
dilate the second digital model in the voxel space.
